(19) United States
(12) Patent Application Publication
(10) Pub. No.: US 2015/0169186 A1
(43) Pub. Date: Jun. 18, 2015

(54) METHOD AND APPARATUS FOR SURFACING CONTENT DURING IMAGE SHARING

(71) Applicants: Hartmut Neven, Malibu, CA (US); Dragomir Anguelov, Mountain View, CA (US); John Flynn, Marina del Rey, CA (US); Mark Joseph Cummins, Santa Monica, CA (US); James William Philbin, Santa Monica, CA (US)

(72) Inventors: Hartmut Neven, Malibu, CA (US); Dragomir Anguelov, Mountain View, CA (US); John Flynn, Marina del Rey, CA (US); Mark Joseph Cummins, Santa Monica, CA (US); James William Philbin, Santa Monica, CA (US)

(21) Appl. No.: 13/422,815

(22) Filed: Mar. 16, 2012

(51) Int. Cl. G06F 3/0484; H04L 29/08; G06K 9/00; G06F 3/048

(52) U.S. Cl. CPC G06F 3/04842; G06K 9/00624; H04L 67/10

(57) ABSTRACT

A method and apparatus for surfacing content during a photo sharing process is described. The method may include detecting the initiation of a social networking photo sharing process for a digital image. The method may also include transmitting digital image data corresponding to the digital image to a content surfacing server to locate content relevant to the digital image. The method may also include receiving one or more items of data relevant to the digital image from the content surfacing server. Furthermore, the method may include presenting a notification, before the digital image is uploaded to a social networking system by the social networking photo sharing process, to a user to indicate that content relevant to the digital image has been received.

### TECHNICAL FIELD

Embodiments of the invention relate to the field of digital image processing, and more particularly, to enable the discovery of information relevant to a digital image during an image sharing process.

### BACKGROUND

The Internet provides a vast amount of knowledge about people, places, and things. The information available on the Internet was made more personal and socially interactive with the advent of social networking. With social networking, users are able to share chat sessions with each other, post comments to each other, share pictures, etc. When a user shares a picture on a social networking system, such as by posting the picture to a feed, the user must first take a picture, and then at a later time upload the picture to the feed. The user may further comment on the picture when uploading it to the social networking system. However, the user must operate different interfaces to create a post, and share a picture. As a result, the user's focus and attention must shift between different interfaces during the photo sharing process.

### SUMMARY

A method and apparatus for surfacing content during a photo sharing process is described. According to an exemplary method, the initiation of a social networking photo sharing process for a digital image is detected. Digital image data corresponding to the digital image are transmitted to a content surfacing server so that content relevant to the digital image may be located. One or more items of data relevant to the digital image are received from the content surfacing server. A notification is then presented, before the digital image is uploaded to the social networking system by the social networking photo sharing process, to a user to indicate that content relevant to the digital image has been received.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of exemplary system architecture for surfacing relevant content during image sharing.

FIG. 2 is a block diagram of one embodiment of a content surfacing client, a content surfacing system, and social networking system.

FIG. 3 is a flow diagram of one embodiment of a method for transparently and automatically surfacing relevant content during a photo sharing process.

FIG. 4 is a flow diagram of one embodiment of a method a content surfacing client processing surfaced content while images are being uploaded to a social networking system.

FIG. 5 illustrates a diagrammatic representation of a machine in the exemplary form of a computer system.

FIG. 6 illustrates an example system for receiving, transmitting, and displaying data.

FIG. 7 illustrates an alternate view of an example system for receiving, transmitting, and displaying data.

FIG. 8 illustrates an example schematic drawing of a computer network infrastructure.

### DETAILED DESCRIPTION

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “detecting”, “transmitting”, “receiving”, “presenting”, “displaying”, “adding”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

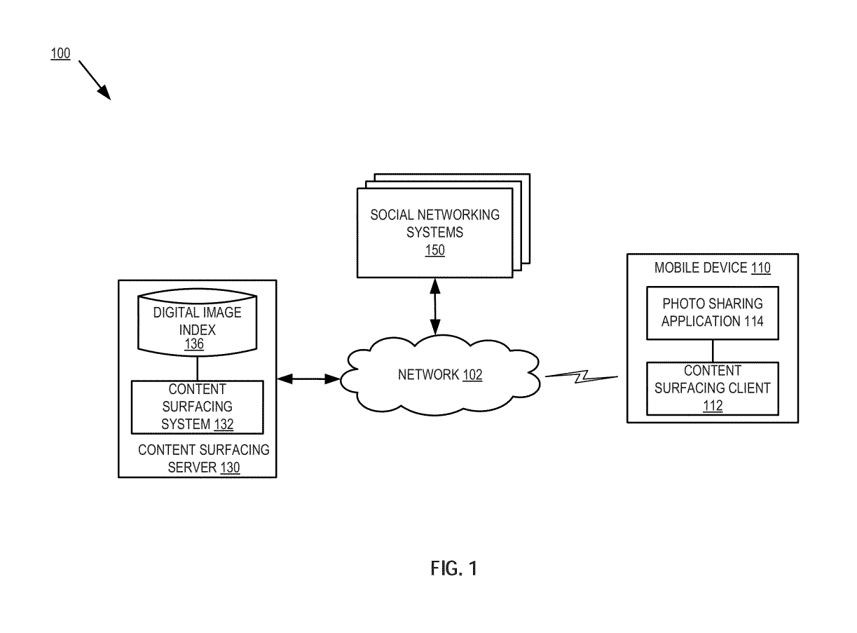

FIG. 1 is a block diagram of exemplary system architecture 100 for surfacing relevant content during image sharing. In one embodiment, the system 100 includes mobile device 110, a content surfacing server 130, and one or more social networking systems 150. In one embodiment, mobile device 110 may be a mobile computing device, such as a mobile telephone, personal digital assistant, tablet computer, wearable computing device, etc. The content surfacing server 130 and social networking systems 150 may also be computing devices, such as server computers, desktop computers, etc.

The mobile device 110, content surfacing server 130, and social networking systems 150 may be coupled to a network 102 that communicates any of the standard protocols for the exchange of information. In one embodiment, mobile device 110 is coupled with network 102 via a wireless connection, such as a cellular telephone connection, wireless fidelity connection, etc. The mobile device 110, content surfacing server 130, and social networking systems 150 may run on one Local Area Network (LAN) and may be incorporated into the same physical or logical system, or different physical or logical systems. Alternatively, the mobile device 110, content surfacing server 130, and social networking systems 150 may reside on different LANs, wide area networks, cellular telephone networks, etc. that may be coupled together via the Internet but separated by firewalls, routers, and/or other network devices. In yet another configuration, the content surfacing server 130 may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

The mobile device 110 is responsible for capturing digital images of real-world objects with a digital camera (not shown) of the mobile device. A real-world object may be a person, place, thing, or activity. In one embodiment, the digital images of the real-world objects may include still photographs, digital video, a sequence of digital photographs, a live video feed, etc. In one embodiment, after mobile device 110 captures a digital image, mobile device 110 may upload the digital image to a remote system for storage, for inclusion in a social networking system post, for inclusion in a web log, etc. In order to avoid obscuring the present invention, the discussion will describe uploading digital images to one or more social networking systems, such as social networking systems 150, although digital images may be uploaded or otherwise transferred to other types of systems, and relevant content surfaced, consistent with the discussion herein.

In one embodiment, when mobile device 110 initiates the upload process for a digital image to one or more of social networking systems 150, content surfacing client 112 obtains one or more items of relevant content associated with the digital image from content surfacing server 130. In one embodiment, content surfacing client 112 is part of photo sharing application 114 supported by one of the social networking systems 150. In another embodiment, content surfacing client 112 is a separate application that interfaces with photo sharing application 114 during a photo sharing process.

As will be discussed in greater detail below, as digital images are uploaded by photo sharing application 114 to one or more social networking systems 150 as part of a normal photo sharing process, content surfacing client 112 transparently and automatically obtains relevant content for the digital images being uploaded before completion of the image upload process. In one embodiment, the relevant content is obtained prior to completion of the digital image uploads, so that a user may include the relevant items of data as data associated with the uploaded digital images. Furthermore, content surfacing client 112 unobtrusively presents the data to the user via a graphical user interface generated by photo sharing application 114, so that notifications for surfaced content and the presentation of the relevant surfaced content data items does not obscure elements of the photo sharing user interface. In one embodiment, the relevant content includes items of data, such as microblogging system entries, social networking posts, digital image feeds, etc. obtained from one or more social networking systems, which are relevant to real world objects within the digital image being uploaded. In one embodiment, the items of data are relevant when the item of data includes a digital image with the same real world object contained within the digital image being uploaded by mobile device 110.

In one embodiment, content surfacing system 132 of content surfacing server 130 enables the automatic suggestion of relevant items of data associated with digital images during the upload process. In one embodiment, when photo sharing application 114 of mobile device 110 begins the uploading process of a digital image to one or more of social networking systems 150, content surfacing client 112 transmits the digital image to content surfacing system 132. In one embodiment, content surfacing client 112 may transmit a low resolution version of the digital image, or a digital signature generated from the image, to the content surfacing system 132 instead of the digital image itself. In one embodiment, content surfacing client 112 may further includes sensor data, such as global positioning system data, time, text to accompany a social networking post, etc., with the digital image.

In one embodiment, when content surfacing system 132 receives the digital image, content surfacing system 132 performs one or more image recognition processes on the digital image to identify one or more real world objects within the digital image. As discussed in more detail below, content surfacing system 132 may generate a digital signature(s), such as a feature vector, for the objects in the digital images. Based on the digital signature, content surfacing system 132 may search one or more databases for objects that match the generated digital signature(s).

In one embodiment, content surfacing system 132 searches digital image index 136. In one embodiment, digital image index 136 stores culled information on real-world objects, along with corresponding digital signatures and one or more potential relevant items of data, such as social networking posts, relevant items of data utilized by microblogging systems, image descriptions, image captions, links, related posts, etc. In one embodiment, the relevant items of data include data obtained from posts of users of one or more social networking systems 150, where the posts include digital images that contain real world objects that match one or more of the real world objects in the digital image being uploaded by photo sharing application 114.

In one embodiment, content surfacing system 132 may locate duplicative relevant items of data for a given digital image. In one embodiment, content surfacing system 132 utilizes the received sensor data to filter the surfaced data results to a set of relevant items of data with greater relevance to a given digital image. In one embodiment, the received sensor data it utilized to filter located relevant items of data based on one or more of time, location, identity of people in a digital image, etc. For example, if a Starbucks™ storefront is recognized in a digital image being uploaded to a social network system 150, content surfacing system 132 may utilize sensor data, such as global positioning sensor data received from a mobile device, to locate a particular Starbucks™ and determine a set of more precise items of data relevant to the particular Starbucks™ in the digital image. If content surfacing system 132 determines that the digital image was taken in Santa Monica, content surfacing system 132 may locate relevant items of data based on the additional data. Thus, content surfacing system 132 could suggest a more relevant topic identifier associated with the image when the image is to be posted to a microblogging website, such as #SantaMonica_Starbucks, locate social networking or microblogging posts by other users that posted pictures of the Santa Monica Starbucks™, obtain reviews of the particular Starbucks™ from a user generated restaurant review website, etc.

In one embodiment, based on results of the image recognition and relevant data searches, content surfacing system 132 transmits the located relevant items of data, as suggested relevant items of data, to content surfacing client 112. In one embodiment, content surfacing client 112 triggers a notification for display by a graphical user interface of photo sharing application 114. In one embodiment, the notification displays the suggested relevant items of data to a user of mobile device 110 prior to completion of the upload of the digital image to one or more of social networking systems 150. In one embodiment, the graphical user interface of photo sharing application 114 displays the received relevant items of data in an unobtrusive way within the photo sharing graphical user interface while the digital images are being uploaded to one of the social networking systems 150. In one embodiment, content surfacing client 112 activates a clickable icon, a summary of results bar, etc. within the photo sharing graphical user interface to indicate to a user of mobile device 110 that relevant content has been found.

In one embodiment, content surfacing client 112 enables users, via the graphical user interface generated by photo sharing application 114, to explore the relevant items of data, such as by clicking on icons, sliding a summary of results bar left or right, etc. In one embodiment, when content surfacing client 112 receives an icon click or a summary of results bar slide request, content surfacing client 112 transmits a request to content surfacing system 132 for additional details for selected items of data, or for additional items of data. In one embodiment, the clickable icons and the summary of results bar, displayed in the graphical user interface generated by photo sharing application 114, occupy a small portion of a display of mobile device 110, leaving the remaining portion of the display available for the typical flow of the photo sharing process and without obscuring the elements of the photo sharing application's graphical user interface.

In one embodiment, photo sharing application 114 receives user selection of one or more suggested relevant items of data, and may additionally or alternatively receive one or more user-created relevant items of data. In one embodiment, photo sharing application 114 provides the user-selected and/or user-created relevant items of data to social networking system 150 when the digital image is uploaded to the social networking system 150. In one embodiment, the relevant items of data are embedded in metadata for the digital image, included in a description of the digital image, utilized in the title for the digital image, included in the text or title of a post that accompanies the digital image, included in the text of a post, etc.

In one embodiment, the automatically surfaced relevant items of data may be located, presented, and selected by a user during the photo upload process to a social networking system 150. Furthermore, because the existence of data relevant to a digital image is presented to a user in an unobtrusive way, and in line with a typical photo sharing flow, the user's attention is not diverted away from the social networking aspects of the photo sharing process. Furthermore, at the moment the user is sharing a digital image on a social networking system, the user's attention is directly focused on the contents of the digital image, the circumstances that prompted the user to share the digital image, and the subject matter of the digital image. In one embodiment, information that is relevant to the subject matter (e.g. others' comments, photos, social networking or microblogging topic identifiers, etc. from social networking systems) is often of interest to the user, and can also influence the user's own comments during the photo sharing process. The user is thus able to make a more relevant selection of data, or is able to create more relevant user-generated data, to be included with the digital image when uploaded to a social networking system, by viewing and selecting other user's comments, other user's posts, other user's microblogging topic identifiers, etc. without diverting the user's attention away from the photo sharing process. Furthermore, when the images are associated with social networking or microblogging topic posts, the relevant content surfacing discussed herein presents the user with relevant and current topic identifiers. As a result, the user is enabled to select relevant social networking or microblogging topic identifiers that can be used to disseminate a post that includes the digital image with an appropriate topic identifier for better discovery by other users.

Although the discussion herein describes a content surfacing client 112 for use by a mobile device 110, in another embodiment consistent with the discussion herein, a content surfacing client may be utilized by a home computing system, such as a desktop computer, laptop computer, tablet computer, etc. In this embodiment, mobile device 110 would transmit digital images to the home computing system for storage. Then, when digital images are uploaded to social networking systems 150 via the home computing system, either automatically by a photo sharing application of the home computer system or in response to a user request to upload the digital images, a content surfacing client of the home computing system would transmit digital image data, obtain notifications and relevant items of data, and present the notification and relevant items of data to a user in line with a photo sharing process at the home computing system, as discussed herein.

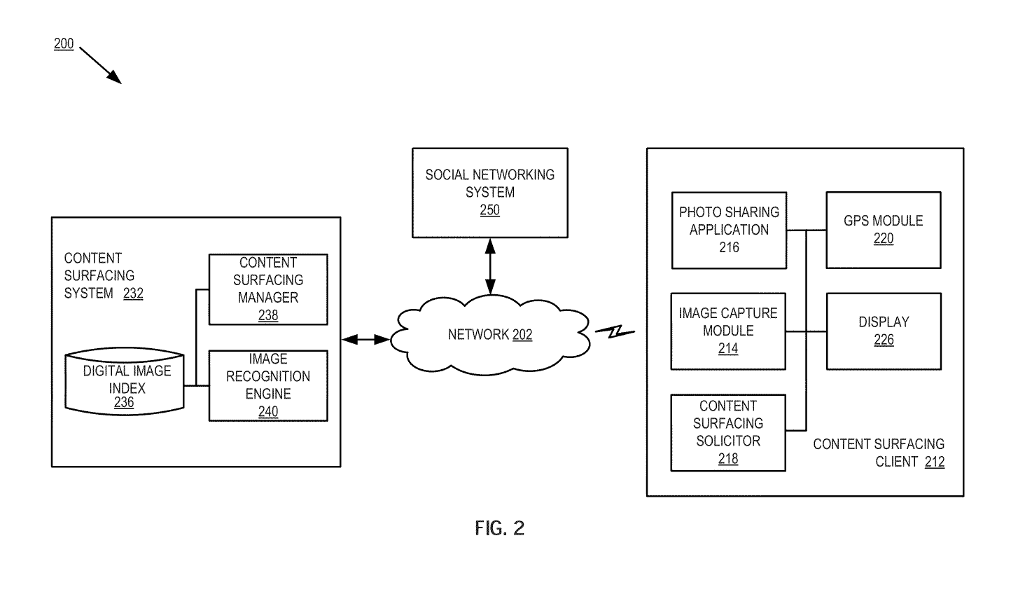

FIG. 2 is a block diagram of one embodiment 200 of content surfacing client 212, content surfacing system 232, and social networking system 250. Content surfacing client 212 and content surfacing system 232 provide additional details for the content surfacing client 112 and content surfacing system 132 discussed above in FIG. 1. Furthermore, although certain functions are described herein as occurring at the content surfacing client 112 or the content surfacing system 132, those functions can be shifted between client 112 and system 132 consistent with the discussion herein.

In one embodiment, content surfacing client 212 may include an image capture module 214, a photo sharing application 216, a content surfacing solicitor 218, a display 226, and a global positioning system (GPS) module 220. In one embodiment, content surfacing system 232 may include an image recognition engine 240, a content surfacing manager 238, and a digital image index 236. In one embodiment, the content surfacing client 212 and content surfacing system 232 communicate with each other over various networks and network configurations as discussed above in FIG. 1.

In the content surfacing client 212, image capture module 214 is responsible for capturing digital images of real world objects. The digital images may include still digital photographs, a series of still digital photographs, a recorded video, a live video feed, etc. In one embodiment, image capture module 214 is a digital camera of a mobile device. In one embodiment, captured digital images are stored in a memory of a mobile device (not shown) coupled with content surfacing client 212. In one embodiment, sensor data, such as GPS data generated by GPS module 220, time data, etc. are stored as metadata of the digital image, or otherwise associated with the digital image.

In one embodiment, photo sharing application 216 generates a graphical user interface on display 226 that may include user interface elements for selecting digital images for upload to social networking system 250, entering social networking post comments, entering user-created relevant items of data, entering web links, etc. In one embodiment, when photo sharing application 216 receives user selection of a digital image to upload to social networking system 250, indicating that a user has initiated a social networking photo sharing process for the digital image, content surfacing solicitor 218 transmits the selected digital image to image recognition engine of content surfacing system 232. As discussed above, instead of transmitting the original digital image, content surfacing system 218 may transmit a lower resolution version of the digital image, or a digital signature generated for the digital image by content surfacing client 212. In an alternative embodiment, in response to an image being captured by image capture module 214, and prior to initiation of the photo sharing application, the digital image, lower resolution version, digital signature, etc. is transmitted to image recognition engine 240 in order to pre-fetch relevant content associated with a digital image.

In one embodiment, image recognition engine 240 receives the digital image from content surfacing client 212. In one embodiment, image recognition engine 240 analyzes the digital image to generate one or more digital signatures for real-world objects within the digital image. As is discussed below, in one embodiment, image recognition engine 240 calculates a feature vector from pixels of the digital image, where values in the feature vector correspond to relevant pixels within the image. This feature vector then becomes a digital signature for each of the real-objects within the digital image.

Image recognition engine 240 utilizes the digital signature to search a digital image index 236. Although the digital image index 236 is illustrated as a component of the content surfacing system 232, the digital image index 236 may be maintained at a remote system (not shown). When image recognition engine 240 finds a match between the digital signature generated for the digital image, and a digital signature within digital image index 236, image recognition engine 240 informs content surfacing manager 238.

In one embodiment, content surfacing manager 238 utilizes the matched index for the digital image to obtain one or more relevant items of data associated with the matched digital image. In one embodiment, content surfacing manager obtains relevant items of data that are associated with the matched image in digital image index 236. In one embodiment, the relevant items of data include social networking posts that include an image that contains the real world object, microblogging posts that include an image that contains the real world object, a photo feed that includes images that contain the real world object, one or more photos, feeds, or posts relevant to a location of the matched real world object, one or more photos, feeds, or posts relevant to a time when the digital image of the real world object was captured, etc.

In one embodiment, content surfacing manager 238 filters located relevant items of data to obtain the most relevant items of data for a given digital image. In one embodiment, content surfacing manager 238 utilizes metadata associated with a digital image, such as GPS data, time data, a user's social networking friends, circles, and/or contacts, etc. to narrow the results. In one embodiment, content surfacing manager 238 selects one or more relevant items of data based on the filtered image matching results, and transmits the relevant items of data to content surfacing solicitor 218. Content surfacing solicitor 218 provides the received suggested relevant items of data as a notification to photo sharing application 216 that content, relevant to the digital image being uploaded, has been found.

In one embodiment, in response to receipt of the suggested relevant items of data, photo sharing application 216 activates a user interface element to unobtrusively notify a user that content relevant to the image being uploaded is available. As discussed herein, the notification is unobtrusive because it does not obscure existing elements of the photo sharing application interface. In one embodiment, the notification may be presented as a clickable icon added to the graphical user interface, a clickable icon modified within the graphical user interface, a summary of results bar displayed in area of the graphical user interface that does not already contain user interface elements, etc. Furthermore, in one embodiment the notification is configured such that it occupies a small portion of a photo sharing graphical user interface.

In one embodiment, display of the suggested relevant items of data enables a user to select which suggested relevant items of data are to be associated with a digital image when posted to social networking system 250. Furthermore, display of the suggested relevant items of data enables a user to review and request additional relevant items of data. In one embodiment, photo sharing application 216 completes the upload of the digital image, along with one or more selected and/or user-created relevant items of data, to social networking system 250.

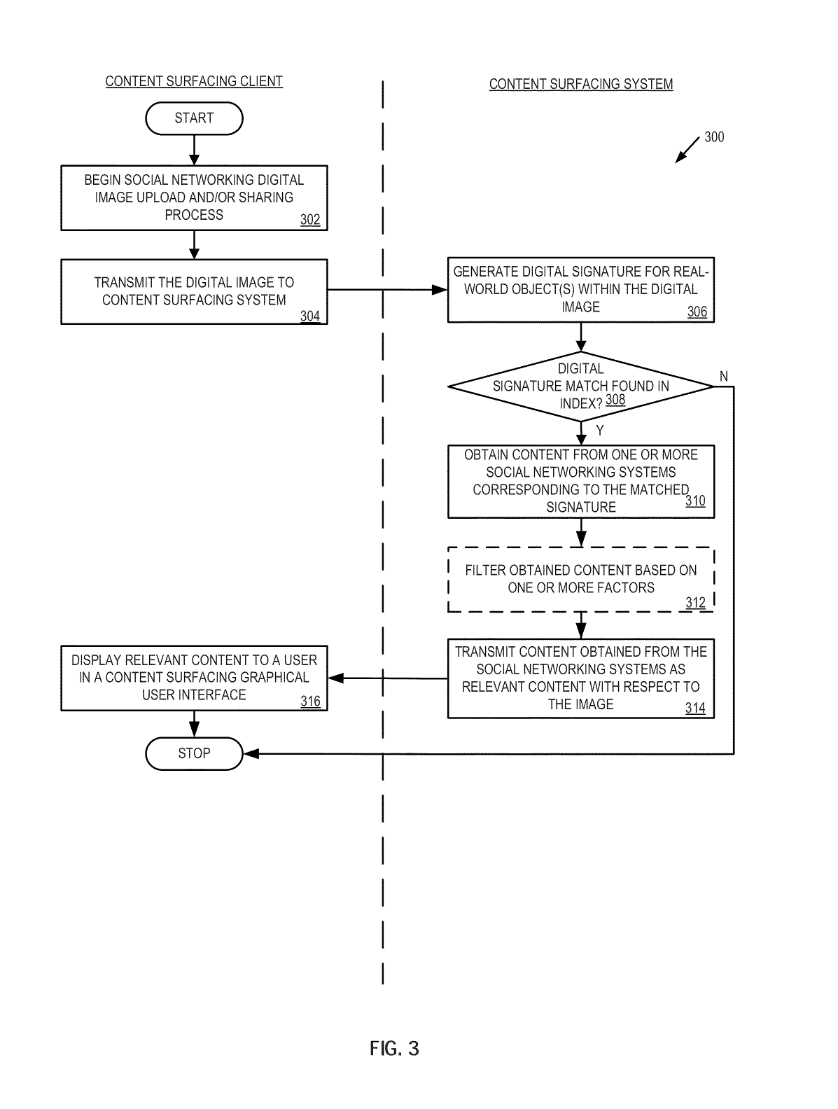

FIG. 3 is a flow diagram of one embodiment of a method 300 for transparently and automatically surfacing relevant content during a photo sharing process. The method 300 is performed by processing logic that may comprise hardware (circuitry, dedicated logic, etc.), software (such as is run on a general purpose computer system or a dedicated machine), firmware, or a combination. In one embodiment, the method 300 is performed by a content surfacing client and a content surfacing system (e.g., content surfacing client 112 or 212, and content surfacing system 132 or 232).

Referring to FIG. 3, processing logic begins by initiating a social networking digital image upload/sharing process (processing block 302). In one embodiment, a mobile device, such as a cellular telephone, tablet computer, wearable processing system, etc., captures the digital image with a camera of the mobile device. The digital image may be a still digital image, video, live video feed, etc. In one embodiment, the real-world object may be any object such as landmarks (e.g., the Eiffel Tower), artwork, buildings, corporate logos, people, movie posters, physical locations, etc.

Processing logic transmits the digital image to a content surfacing system (processing block 304). In one embodiment, the digital image is transmitted to the content surfacing system in response to the image being selected for upload to a social networking system. In one embodiment, processing logic transmits, transparently to a user of a photo sharing application, the digital image to a content surfacing system. In one embodiment, additional data, such as global positioning system data, a user's comments typed to the point of uploading the image, etc. may also be transmitted to the content surfacing system. Thus, in one embodiment, relevant content may be surfaced automatically and transparently, without altering the typical digital image sharing/uploading flow for a social networking system. Furthermore, because the user need not initiate the request for relevant content during the photo sharing process, the user's attention is not diverted from the digital image or the circumstances that prompted the user to share the digital image.

In another embodiment, the digital image is transmitted to the content surfacing system in response to the image being captured, so that relevant content may be surfaced for the digital image prior to the initiation of a social networking photo sharing process, consistent with the discussion herein. Furthermore, instead of the captured digital image being transmitted to the content surfacing system, in some embodiments, a reduced resolution version of the digital image, a digital signature generated from the digital image, etc. is transmitted to the content surfacing system by processing logic.

In one embodiment, processing logic then generates a digital signature for the real-world object(s) within the digital image (processing block 306). In one embodiment, processing logic of the content surfacing client computes the image signature on a mobile device. In this embodiment, the content surfacing client transmits the image signature, and not the corresponding image, to the content surfacing system. Transmission of the digital signature, and not the image itself, consumes less bandwidth when transmitted, and thus can be uploaded faster by the content surfacing system. In one embodiment, an intermediate form of the image, such as a low resolution preview, could also be transmitted instead of, or with, a digital signature. In yet another embodiment, both the content surfacing client and the content surfacing system generate digital signatures for the real-world object. In the embodiments discussed above, the digital signature is a feature vector generated from the digital image of the real-world object and provides a unique identification of the real-world object.

Processing logic utilizes the digital signature(s) to search an index of digital images (processing block 308). When a match is found in the digital image index, processing logic searches for relevant items of data associated with the image of the indexed real-world object (processing block 310). In one embodiment, processing logic may search a database of social networking posts, microblogging posts, digital image feeds, etc. that contain digital images with the matched digital signature (i.e., relevant items of data from one or more social networking systems that include an image with a real world object that is also within the digital image selected to be uploaded to a social networking system).

When a match is not found at processing block 308, the process ends. In one embodiment, when no relevant content items are found, a user is not presented with a notification icon, summary of results bar, etc. Thus, the user is not presented with an irrelevant notification that no results were found.

In one embodiment, after the content has been obtained at processing block 310, processing logic advances to processing block 312 to filter located relevant content based on one or more criteria (processing block 312). In one embodiment, the one or more criteria include utilizing sensor data associated with a digital image as measures of relevancy to relevant items of data. In one embodiment, GPS data may be utilized to narrow relevant items of data by location, time data may be utilized to narrow relevant items of data by recent trends, common temporal usage. In one embodiment, social networking data may be utilized to filter located relevant content, such as filtering for posts from members in a social networking circle, posts from social networking friends, posts linked to a user via a professional affiliation network, etc.

Based on results of the search for relevant content and filtering, processing logic transmits one or more suggested items of relevant content to content surfacing client (processing block 314). Processing logic displays a notification that relevant content has been found in a graphical user interface of a photo sharing application (processing block 316). In one embodiment, the notification is rendered in an unobtrusive fashion, such as a clickable icon, slideable summary of results bar, etc. that occupies a small portion of the photo sharing application's graphical user interface.

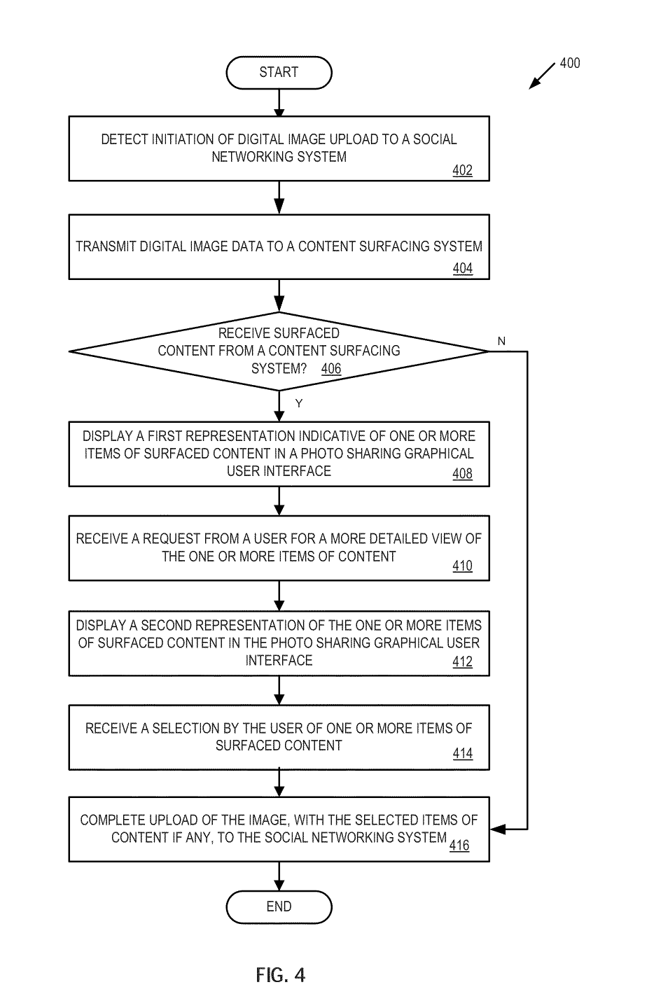

FIG. 4 is a flow diagram of one embodiment of a method 400 a content surfacing client processing surfaced content while images are being uploaded to a social networking system. The method 400 is performed by processing logic that may comprise hardware (circuitry, dedicated logic, etc.), software (such as is run on a general purpose computer system or a dedicated machine), firmware, or a combination. In one embodiment, the method 400 is performed by a content surfacing system (e.g., content surfacing system 132 or 232).

Referring to FIG. 4, processing logic begins by detecting the initiation of digital image upload to a social networking system (processing block 402). As discussed above, a digital image, video, or video feed is captured by a mobile device. In one embodiment, processing logic may detect that an image has been selected for upload to a social networking system, or that the digital image upload has been initiated.

Processing logic transmits digital image data to a content surfacing system (processing block 404). As discussed above, the digital image data may include the digital image itself, a low resolution version of the image, one or more digital signatures computed from the digital image, etc. Furthermore, the digital image data may also include additional data, such as global positioning system data, a user's comments typed to the point of uploading the image, etc. In one embodiment, the additional data is transmitted with the digital image as image metadata. In another embodiment, the additional data is transmitted to the content surfacing system separately from the digital image data.

Processing logic then receives surfaced relevant content from a content surfacing system (processing block 404). In one embodiment, the received content may include one or more items of data, such as social networking posts, microblogging entries, digital image captions, links to digital image feeds, etc. that are relevant to the digital image being uploaded to the social networking system. Furthermore, the items of data are relevant to the digital image being uploaded to the social networking system because the items of data each contain images with a real world object that is also within the digital image. Furthermore, each of the relevant items of data may be related to the digital image in another way, such as proximity to a real world location where an image was captured, when an image was captured, who captured the related image (i.e., social networking friends), etc.

Processing logic determines whether any relevant content items have been surfaced by the content surfacing system (processing block 406). That is, in one embodiment, processing logic may receive a notification that no relevant content items were found by a content surfacing system. In this case, processing logic would proceed to processing block 416 to complete the upload of the digital image to a social networking system. Since notifications are not displayed to a user when relevant content cannot be located, a user's attention is not diverted during the image upload process. However, when processing logic receives one or more items of relevant data, such as relevant surfaced content items, processing logic proceeds to processing block 408.

Processing logic displays a first representation indicative of one or more items of surfaced content in a photo sharing graphical user interface (processing block 408). In one embodiment, the first representation may be a notification displayed in the graphical user interface in an unobtrusive way. For example, the notification may be displayed in a clickable icon, an existing icon may be modified and rendered, a summary of results bar may be added to the graphical user interface, etc. In one embodiment, the notification is displayed in an unobtrusive way within the photo sharing graphical user interface, such as by occupying a relatively small portion of the photo sharing graphical user interface and/or occupying a previously unused portion of the graphical user interface. In one embodiment, the rendering of an unobtrusive notification ensures that the notification does not distract the user's attention from the photo sharing and uploading process, while still providing the user a notification that content relevant to the image has been found.

Processing logic receives a request from a user for a more detailed view of the one or more items of content (processing block 410). In one embodiment, the request may be receipt of a user's selection of a clickable icon. In one embodiment, the request may be receipt of a user's scrolling of a summary of results bar left or right. In either case, processing logic displays a second representation of the one or more items of surfaced content in the photo sharing graphical user interface (processing block 412). In one embodiment, the second representation may display additional details for surfaced content, such as transforming a clickable icon into a detailed summary of results. In another embodiment, the second representation may display additional items of content, such as when a user slides a summary of results bar left or right.

Processing logic receives a user selection of one or more items of surfaced content (processing block 414), and completes the digital image upload with the selected items of content (processing block 416). In one embodiment, the selected items of content are to accompany the digital image on a social networking web site. In embodiments discussed herein, the selected items of content may serve as, or supplement user created, microblogging topic identifiers associated with the digital image, microblogging posts about or that contain the digital image, social networking posts about or that contain the digital image, a caption for a digital image, links associated with the digital image, etc.

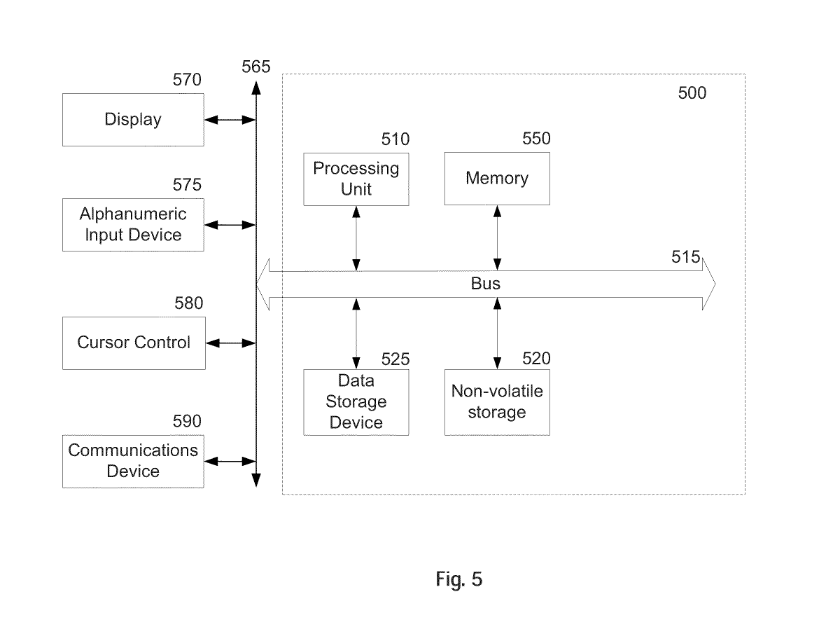

FIG. 5 is one embodiment of a computer system that may be used with the present invention. It will be apparent to those of ordinary skill in the art, however that other alternative systems of various system architectures may also be used.

The data processing system illustrated in FIG. 5 includes a bus or other internal communication means 515 for communicating information, and a processor 510 coupled to the bus 515 for processing information. The system further comprises a random access memory (RAM) or other volatile storage device 550 (referred to as memory), coupled to bus 515 for storing information and instructions to be executed by processor 510. Main memory 550 also may be used for storing temporary variables or other intermediate information during execution of instructions by processor 510. The system also comprises a read only memory (ROM) and/or static storage device 520 coupled to bus 515 for storing static information and instructions for processor 510, and a data storage device 525 such as a magnetic disk or optical disk and its corresponding disk drive. Data storage device 525 is coupled to bus 515 for storing information and instructions.

The system may further be coupled to a display device 570, such as a cathode ray tube (CRT) or a liquid crystal display (LCD) coupled to bus 515 through bus 565 for displaying information to a computer user. An alphanumeric input device 575, including alphanumeric and other keys, may also be coupled to bus 515 through bus 565 for communicating information and command selections to processor 510. An additional user input device is cursor control device 580, such as a mouse, a trackball, stylus, or cursor direction keys coupled to bus 515 through bus 565 for communicating direction information and command selections to processor 510, and for controlling cursor movement on display device 570.

Another device, which may optionally be coupled to computer system 500, is a communication device 590 for accessing other nodes of a distributed system via a network. The communication device 590 may include any of a number of commercially available networking peripheral devices such as those used for coupling to an Ethernet, token ring, Internet, or wide area network. The communication device 590 may further be a null-modem connection, or any other mechanism that provides connectivity between the computer system 500 and the outside world. Note that any or all of the components of this system illustrated in FIG. 5 and associated hardware may be used in various embodiments of the present invention.

It will be appreciated by those of ordinary skill in the art that any configuration of the system may be used for various purposes according to the particular implementation. The control logic or software implementing the present invention can be stored in main memory 550, mass storage device 525, or other storage medium locally or remotely accessible to processor 510.

It will be apparent to those of ordinary skill in the art that the system, method, and process described herein can be implemented as software stored in main memory 550 or read only memory 520 and executed by processor 510. This control logic or software may also be resident on an article of manufacture comprising a computer readable medium having computer readable program code embodied therein and being readable by the mass storage device 525 and for causing the processor 510 to operate in accordance with the methods and teachings herein.

The present invention may also be embodied in a handheld or portable device containing a subset of the computer hardware components described above. For example, the handheld device may be configured to contain only the bus 515, the processor 510, and memory 550 and/or 525. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 510, a data storage device 525, a bus 515, and memory 550, and only rudimentary communications mechanisms, such as a small touch-screen that permits the user to communicate in a basic manner with the device. In general, the more special-purpose the device is, the fewer of the elements need be present for the device to function.

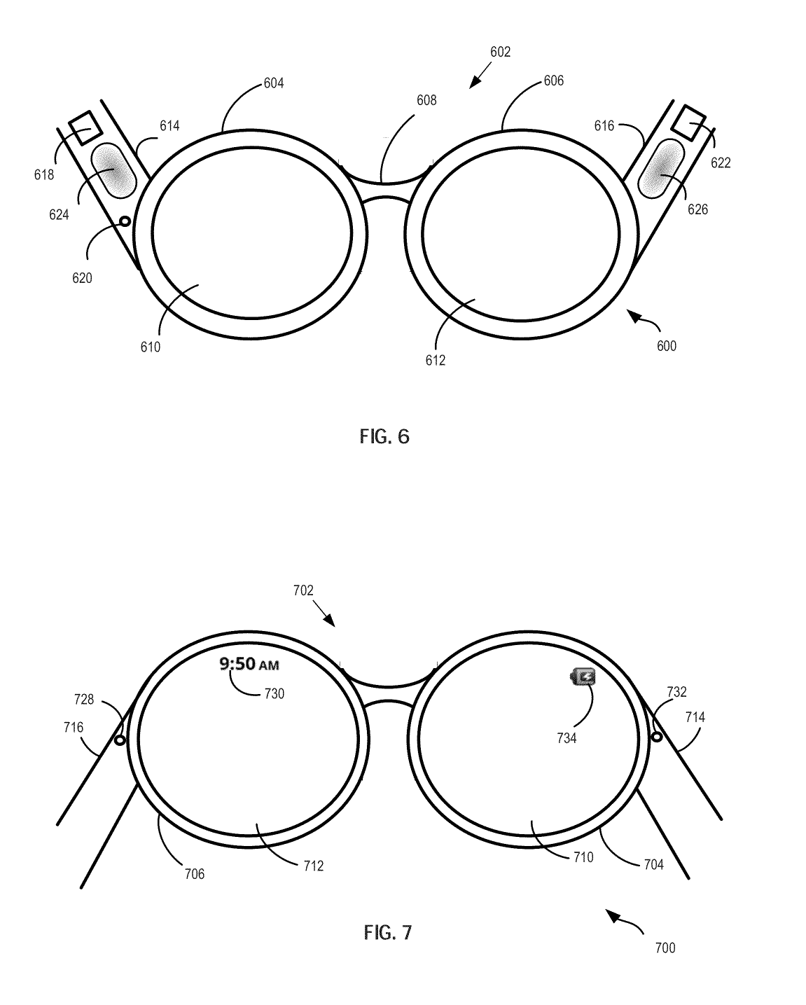

FIG. 6 illustrates an example system 600 for receiving, transmitting, and displaying data. The system 600 is shown in the form of a wearable computing device. While FIG. 6 illustrates eyeglasses 602 as an example of a wearable computing device, other types of wearable computing devices could additionally or alternatively be used, such as a monocular wearable computing device with a single eye head mounted display. As illustrated in FIG. 6, the eyeglasses 602 comprise frame elements including lens-frames 604 and 606 and a center frame support 608, lens elements 610 and 612, and extending side-arms 614 and 616. The center frame support 608 and the extending side-arms 614 and 616 are configured to secure the eyeglasses 602 to a user's face via a user's nose and ears, respectively. Each of the frame elements 604, 606, and 608 and the extending side-arms 614 and 616 may be formed of a solid structure of plastic or metal, or may be formed of a hollow structure of similar material so as to allow wiring and component interconnects to be internally routed through the eyeglasses 602. Each of the lens elements 610 and 612 may be formed of any material that can suitably display a projected image or graphic. Each of the lens elements 610 and 612 may also be sufficiently transparent to allow a user to see through the lens element. Combining these two features of the lens elements can facilitate an augmented reality or heads-up display where the projected image or graphic is superimposed over a real-world view as perceived by the user through the lens elements.

The extending side-arms 614 and 616 are each projections that extend away from the frame elements 604 and 606, respectively, and are positioned behind a user's ears to secure the eyeglasses 602 to the user. The extending side-arms 614 and 616 may further secure the eyeglasses 602 to the user by extending around a rear portion of the user's head. Additionally or alternatively, for example, the system 600 may connect to or be affixed within a head-mounted helmet structure. Other possibilities exist as well.

The system 600 may also include an on-board computing system 618, a video camera 620, a sensor 622, and finger-operable touch pads 624, 626. The on-board computing system 618 is shown to be positioned on the extending side-arm 614 of the eyeglasses 602; however, the on-board computing system 618 may be provided on other parts of the eyeglasses 602. The on-board computing system 618 may include a processor and memory, for example. The on-board computing system 618 may be configured to receive and analyze data from the video camera 620 and the finger-operable touch pads 624, 626 (and possibly from other sensory devices, user interfaces, or both) and generate images for output from the lens elements 610 and 612.

The video camera 620 is shown to be positioned on the extending side-arm 614 of the eyeglasses 602; however, the video camera 620 may be provided on other parts of the eyeglasses 602. The video camera 620 may be configured to capture images at various resolutions or at different frame rates. Many video cameras with a small form-factor, such as those used in cell phones or webcams, for example, may be incorporated into an example of the system 600. Although FIG. 6 illustrates one video camera 620, more video cameras may be used, and each may be configured to capture the same view, or to capture different views. For example, the video camera 620 may be forward facing to capture at least a portion of the real-world view perceived by the user. This forward facing image captured by the video camera 620 may then be used to generate an augmented reality where computer generated images appear to interact with the real-world view perceived by the user.

The sensor 622 is shown mounted on the extending side-arm 616 of the eyeglasses 602; however, the sensor 622 may be provided on other parts of the eyeglasses 602. The sensor 622 may include one or more of a gyroscope or an accelerometer, for example. Other sensing devices may be included within the sensor 622 or other sensing functions may be performed by the sensor 622.

The finger-operable touch pads 624, 626 are shown mounted on the extending side-arms 614, 616 of the eyeglasses 602. Each of finger-operable touch pads 624, 626 may be used by a user to input commands. The finger-operable touch pads 624, 626 may sense at least one of a position and a movement of a finger via capacitive sensing, resistance sensing, or a surface acoustic wave process, among other possibilities. The finger-operable touch pads 624, 626 may be capable of sensing finger movement in a direction parallel or planar to the pad surface, in a direction normal to the pad surface, or both, and may also be capable of sensing a level of pressure applied. The finger-operable touch pads 624, 626 may be formed of one or more translucent or transparent insulating layers and one or more translucent or transparent conducting layers. Edges of the finger-operable touch pads 624, 626 may be formed to have a raised, indented, or roughened surface, so as to provide tactile feedback to a user when the user's finger reaches the edge of the finger-operable touch pads 624, 626. Each of the finger-operable touch pads 624, 626 may be operated independently, and may provide a different function.

FIG. 7 illustrates an alternate view 700 of the system 600 of FIG. 6. As shown in FIG. 7, the lens elements 710 and 712 may act as display elements. The eyeglasses 702 may include a first projector 728 coupled to an inside surface of the extending side-arm 716 and configured to project a display 730 onto an inside surface of the lens element 712. Additionally or alternatively, a second projector 732 may be coupled to an inside surface of the extending side-arm 714 and configured to project a display 734 onto an inside surface of the lens element 710.

The lens elements 710 and 712 may act as a combiner in a light projection system and may include a coating that reflects the light projected onto them from the projectors 728 and 732. In some embodiments, a special coating may not be used (e.g., when the projectors 728 and 732 are scanning laser devices).

In alternative embodiments, other types of display elements may also be used. For example, the lens elements 710, 712 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 704 and 706 for driving such a matrix display. Alternatively or additionally, a laser or LED source and scanning system could be used to draw a raster display directly onto the retina of one or more of the user's eyes. Other possibilities exist as well.

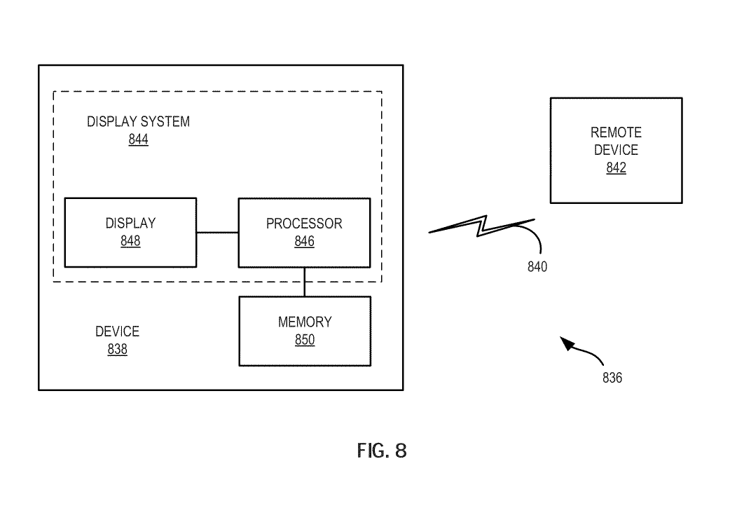

FIG. 8 illustrates an example schematic drawing of a computer network infrastructure. In one system 836, a device 838 communicates using a communication link 840 (e.g., a wired or wireless connection) to a remote device 842. The device 838 may be any type of device that can receive data and display information corresponding to or associated with the data. For example, the device 838 may be a heads-up display system, such as the eyeglasses 602 and 702 described with reference to FIGS. 6 and 7.

Thus, the device 838 may include a display system 844 comprising a processor 846 and a display 848. The display 848 may be, for example, an optical see-through display, an optical see-around display, or a video see-through display. The processor 846 may receive data from the remote device 842, and configure the data for display on the display 848. The processor 846 may be any type of processor, such as a micro-processor or a digital signal processor, for example.

The device 838 may further include on-board data storage, such as memory 850 coupled to the processor 846. The memory 850 may store software that can be accessed and executed by the processor 846, for example.

The remote device 842 may be any type of computing device or transmitter including a laptop computer, a mobile telephone, etc., that is configured to transmit data to the device 838. The remote device 842 and the device 838 may contain hardware to enable the communication link 840, such as processors, transmitters, receivers, antennas, etc.

In FIG. 8, the communication link 840 is illustrated as a wireless connection; however, wired connections may also be used. For example, the communication link 840 may be a wired link via a serial bus such as a universal serial bus or a parallel bus. A wired connection may be a proprietary connection as well. The communication link 840 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 142 may be accessible via the Internet and may comprise a computing cluster associated with a particular web service (e.g., social-networking, photo sharing, address book, etc.).

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A computer-implemented method, comprising:
detecting, with a computer processing system, initiations of a social networking photo sharing process for digital images, each initiation for a respective digital image that depicts at least one real world object within the digital image, the initiations being performed in a photo sharing user interface having a set of photo sharing user interface elements, and for each initiation:
transmitting digital image data corresponding to the digital image to a content surfacing server to locate content relevant to the digital image; and
determining whether one or more items of data relevant to the digital image were found by the content surfacing server, wherein the one or more items of data are one or more social networking system posts, and each of the one or more social networking posts include a digital image with a depiction of a real world object relevant to the at least one real world object within the digital image;
for each initiation for which one or more items of data relevant to the digital image are determined to be found by the content surfacing server:
receiving one or more items of data relevant to the digital image from the content surfacing server; and
presenting a notification during the sharing process, before the digital image is uploaded to a social networking system by the social networking photo sharing process, to a user to indicate that content relevant to the digital image has been received, wherein the notification is added to the photo sharing user interface such that the notification does not obstruct views of the photo sharing user interface elements;
receiving user selection of the notification in a photo sharing graphical user interface; and
in response to the user selection of the notification, displaying a description of each of the one or more items of data relevant to the digital image;
for each initiation for which one or more items of data relevant to the digital image are determine not to be found by the content surfacing server, not presenting a notification that no items of data relevant to the digital image were found nor the notification to indicate that content relevant to the digital image has been received during the sharing process.

2. (canceled)

3. The computer-implemented method of claim 1, further comprising:
in response to user selection of at least one of the one or more items of data, adding the selected at least one of the one or more items of data to the digital image before the digital image upload to the social networking system by the social networking photo sharing process is completed.

4. The computer-implemented method of claim 1, wherein the digital image data is transmitted to the content surfacing server in response to the detection of the initiation of the social networking photo sharing process, and without receipt of a user request for the one or more items of data.

5. The computer-implemented method of claim 1, wherein an item of data is relevant to the digital image when a second digital image that is associated with the item of data contains a real world object that is also contained within the digital image.

6. The computer-implemented method of claim 1, wherein each of the one or more items of data are an item of data obtained from a social networking system.

7. The computer-implemented method of claim 1, wherein the computer processing system is a home computing device, and the notification is presented in one of a content-sharing website or content-sharing application.

8. The computer-implemented method of claim 1, wherein the computer processing system is a user-wearable computing device in the form of eyeglasses.

9. The computer-implemented method of claim 1, wherein the computer processing system is a mobile telephone.

10. The computer-implemented method of claim 1, wherein the notification is presented in a graphical user interface, and wherein the graphical user interface is configured to display the notification without obscuring other graphical user interface elements.

11. The computer-implemented method of claim 1, wherein the content surfacing server is to receive the digital image data, perform one or more image recognition processes on the image data to generate a digital signature for the at least one real world object depicted within the digital image, perform a search of social networking posts on one or more social network systems utilizing the digital signature, and provide the one or more relevant items of data from the one or more social networking systems when at least one social networking posts from the one or more social networking systems includes a depiction of an object with a digital signature that matches the digital signature for the at least one real world object depicted within the digital image.

12. A non-transitory computer readable storage medium including instructions that, when executed by a processor, cause the processor to perform a method comprising:
detecting initiations of a social networking photo sharing process for digital images, each initiation for a respective digital image that depicts at least one real world object within the digital image, the initiations being performed in a photo sharing user interface having a set of photo sharing user interface elements, and for each initiation:
transmitting digital image data corresponding to the digital image to a content surfacing server to locate content relevant to the digital image; and
determining whether one or more items of data relevant to the digital image were found by the content surfacing server, wherein the one or more items of data are one or more social networking system posts, and each of the one or more social networking posts include a digital image with a depiction of a real world object relevant to the at least one real world object within the digital image;
for each initiation for which one or more items of data relevant to the digital image are determined to be found by the content surfacing server:
receiving, during the sharing process, one or more items of data relevant to the digital image from the content surfacing server; and
presenting a notification, before the digital image is uploaded to a social networking system by the social networking photo sharing process, to a user to indicate that content relevant to the digital image has been received, wherein the notification is added to the photo sharing user interface such that the notification does not obstruct views of the photo sharing user interface elements;
receiving user selection of the notification in a photo sharing graphical user interface; and
in response to the user selection of the notification, displaying a description of each of the one or more items of data relevant to the digital image;
for each initiation for which one or more items of data relevant to the digital image are determine not to be found by the content surfacing server, not presenting a notification that no items of data relevant to the digital image were found nor the notification to indicate that content relevant to the digital image has been received during the sharing process.

13. (canceled)

14. The computer readable storage medium of claim 12, further comprising:
in response to user selection of at least one of the one or more items of data, adding the selected at least one of the one or more items of data to the digital image before the digital image upload to the social networking system by the social networking photo sharing process is completed.

15. The computer readable storage medium of claim 14, wherein the digital image data is transmitted to the content surfacing server in response to the detection of the initiation of the social networking photo sharing process, and without receipt of a user request for the one or more items of data.

16. The computer readable storage medium of claim 12, wherein an item of data is relevant to the digital image when a second digital image that is associated with the item of data contains a real world object that is also contained within the digital image.

17. The computer readable storage medium of claim 12, wherein each of the one or more items of data are an item of data obtained from a social networking system.

18. The computer readable storage medium of claim 12, wherein the computer processing system is a home computing device, and the notification is presented in one of a content-sharing website or content-sharing application.

19. The computer readable storage medium of claim 12, wherein the computer processing system is a user-wearable computing device in the form of eyeglasses.

20. The computer readable storage medium of claim 12, wherein the computer processing system is a mobile telephone.

21. The computer readable storage medium of claim 12, wherein the notification is presented in a graphical user interface, and wherein the graphical user interface is configured to display the notification without obscuring other graphical user interface elements.

22. A system comprising:
a memory to store one or more digital images; and
a processor coupled with the memory to:
detect initiations of a social networking photo sharing process for digital images, each initiation for a respective digital image for the one or more digital images that depicts at least one real world object within the digital image, the initiations being performed in a photo sharing user interface having a set of photo sharing user interface elements, and for each initiation:
transmit digital image data corresponding to the digital image to a content surfacing server to locate content relevant to the digital image, and
determining whether one or more items of data relevant to the digital image were found by the content surfacing server, wherein the one or more items of data are one or more social networking system posts, and each of the one or more social networking posts include a digital image with a depiction of a real world object relevant to the at least one real world object within the digital image;
for each initiation for which one or more items of data relevant to the digital image are determined to be found by the content surfacing server:
receive, during the sharing process, one or more items of data relevant to the digital image from the content surfacing server, and
present a notification, during the sharing process and before the digital image is uploaded to a social networking system by the social networking photo sharing process, to a user to indicate that content relevant to the digital image has been received, wherein the notification is added to the photo sharing user interface such that the notification does not obstruct views of the photo sharing user interface elements;
receiving user selection of the notification in a photo sharing graphical user interface; and
in response to the user selection of the notification, displaying a description of each of the one or more items of data relevant to the digital image;
for each initiation for which one or more items of data relevant to the digital image are determine not to be found by the content surfacing server, not presenting a notification that no items of data relevant to the digital image were found nor the notification to indicate that content relevant to the digital image has been received during the sharing process.
